(19) United States
(12) Patent Application Publication
(10) Pub. No.: US 2002/0170943 A1
(43) Pub. Date: Nov. 21, 2002

(54) Solder bonding technique for assembling a tilted detector chip

(75) Inventor: Philip Deane, Durham, NC (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/152,641

(22) Filed: May 21, 2002

Related U.S. Application Data
(60) Provisional application No. 60/291,948, filed on May 21, 2001.

(51) Int. Cl. B23K 31/02

(52) U.S. Cl. 228/180.22; 228/248.1

(57) ABSTRACT

A method for solder bonding a photodiode or an array of photodiodes to a substrate, the photodiode(s) tilted at a predetermined angle, uses a pair solder bumps placed on a photodiode chip opposite a corresponding pair of asymmetric solder pads placed on the substrate. When the photodiode chip is placed on the substrate, with the solder bumps therebetween, the solder is melted and undergoes a reflow over the surface of the pads. This causes the chip to tilt to one side about the axis defined by the asymmetric pads.

### RELATED APPLICATIONS

This application claims priority from U.S. provisional application No. 60/291,948 filed May 21, 2001.

### TECHNICAL FIELD

This invention relates to techniques for mounting elements on a substrate, and more specifically, to a method of soldering a plurality of small electronic elements such as photodiodes, to a substrate.

### BACKGROUND ART

In edge emitting laser diode systems, a monitor photodiode is used in a feedback loop to control the laser chip's power output. The photodiode's active surface must be pointed toward the laser chip's backside facet. The angle between the photodiode's active surface and the incident laser beam from the laser chip does not need to be 90 degrees; angles between 30 and 60 degrees are acceptable.

Power monitoring photodiodes used in edge emitting pump and source lasers are often assembled in a manner to receive an optical beam and convert the optical signal into an electrical one. Typically, the photodiode is mounted to a submount that is then joined to a substrate that includes the edge emitting laser chip. The submount is assembled to the substrate such that the photodiode is perpendicular to the light path from the laser chip (FIG. 1).

It is known to mount elements on a substrate using solder bumping or solder printing. Flip-chip technology is also well known in the art. Generally, flip-chip technology involves chips with numerous solder bump interconnection terminals. After solder joining the chip to a substrate, the arrangement of solder bumps results in the chip being oriented parallel to the substrate, assuming that all the bumps are of substantially equal size. If there are just two solder bumps or if the bumps are arranged in a line, the chip would be unstable during the solder joining process and it would tend to tilt to one side or the other. This behaviour is the basis of the present invention.

It would be desirable to provide a controllable method of assembling one or many small electronic elements such as photodiodes at an angle to the substrate, using soldering or an equivalent approach. The angle is measured between the main surface of the substrate and the major surface of the element or elements.

### SUMMARY OF THE INVENTION

In accordance with one aspect of the invention, there is provided a method of bonding an element to a substrate at an angle, the method comprising the following steps, not necessarily in the listed order:

a) providing a substrate having a generally flat surface,

b) placing two or more solder bumps on either the substrate or on the element, the bumps defining a single axis,

c) providing means for asymmetrical flow of the solder bumps upon melting,

d) effecting a contact of the element with the substrate through the solder bumps, and

e) heating the solder bumps to cause a non-uniform flow of the solder bumps and a tilting displacement of the element substantially about the axis defined by the solder bumps.

The step d) may be preceded by a step of temporarily attaching the element to a transfer plate or an equivalent transfer device. The step e) is usually followed by natural or forced cooling of the solder bumps to develop a working, fixed connection between the element and the substrate.

In an embodiment of the invention, the element is of sufficiently small dimensions to match the size of a typical solder bump i.e. from several microns to a few millimeters. The element may be a photodiode. In an embodiment of the invention, the element may be mounted on a submount.

### BRIEF DESCRIPTION OF THE DRAWINGS

The invention will now be explained in more detail by way of the following description to be taken in conjunction with the drawings in which

FIG. 1 is a side view of a typical, prior art arrangement combining an edge emitting laser diode and monitor photodiode,

FIG. 2 is an isometric view of the substrate and a photodiode chip mounted on a transfer plate before the assembly, for ease of viewing,

FIG. 3 is a side view of the substrate and the photodiode chip after contact and initial heating and cooling of the solder,

FIG. 4 is a top view illustrating exemplary solder bumps and pads on the substrate and the photodiode chip,

FIG. 5 shows alternative shapes of the pads, and

FIGS. 6a and 6b shows the front view and side view, respectively, of the substrate and a photodiode submount after the reflow of the solder.

### DETAILED DESCRIPTION OF THE EMBODIMENTS OF THE INVENTION

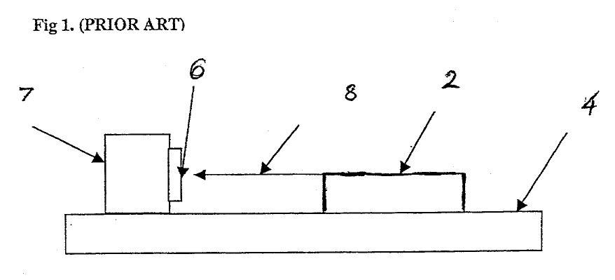

Turning now to FIG. 1, a laser diode 2 is shown mounted on a substrate 4. A photodiode 6, affixed to a submount 7, is also secured to the substrate 4. The laser diode emits an optical beam 8 towards the photodiode.

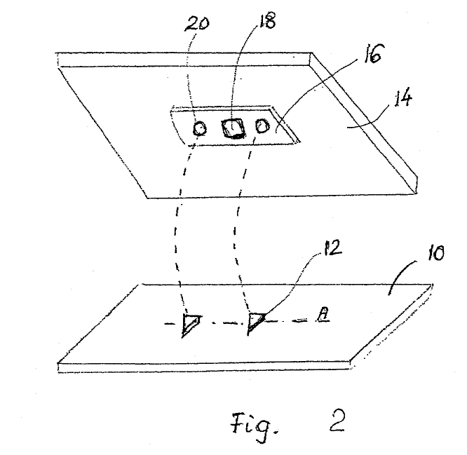

FIG. 2 shows a substrate 10 with two solder pads 12. The material of the substrate and the pads is conventional. The pads 12 have a non-symmetrical shape relative to an imaginary line, or axis A, connecting geometrical centers of the pads. In the embodiment illustrated herein, the shapes are identical triangles, not necessarily of exact geometrical shape. As illustrated in FIG. 5, other asymmetrical shapes are also acceptable for the purpose of the invention.

A die placement machine with a pick-up head 14 is shown with a photodiode chip 16 held in position thereon. The chip has a diode active area 18 and two round solder bumps 20. The solder may be a conventional Pb/Sn solder or another solder commonly used in the art. The size of the bumps 20 and their distribution is selected to match the size and distribution of the pads 12 on the substrate 10. More specifically, the size of the bumps may be such that the solder, when melted, covers at least most of the surface of the respective pad and still forms a relatively thick layer, sufficient to flow and form a “hill” with a slope enabling the chip to tilt as will be explained and illustrated hereinbelow.

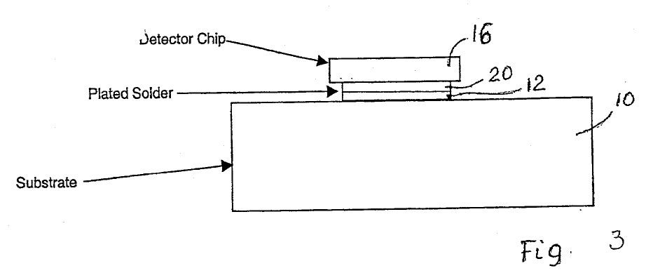

In accordance with the invention, the chip (or another element) is temporarily immobilized on the substrate by bringing the chip in contact with the pad via the solder, and then by controlled heating and cooling of the solder. The result is shown in FIG. 3. The chip 16 is shown after its release from the pick-up head 14. It will be recognized that the method for placing the chip is not a prerequisite for the invention and other methods of bringing the chip in contact with the substrate can easily be conceived by a person with average skill in the art.

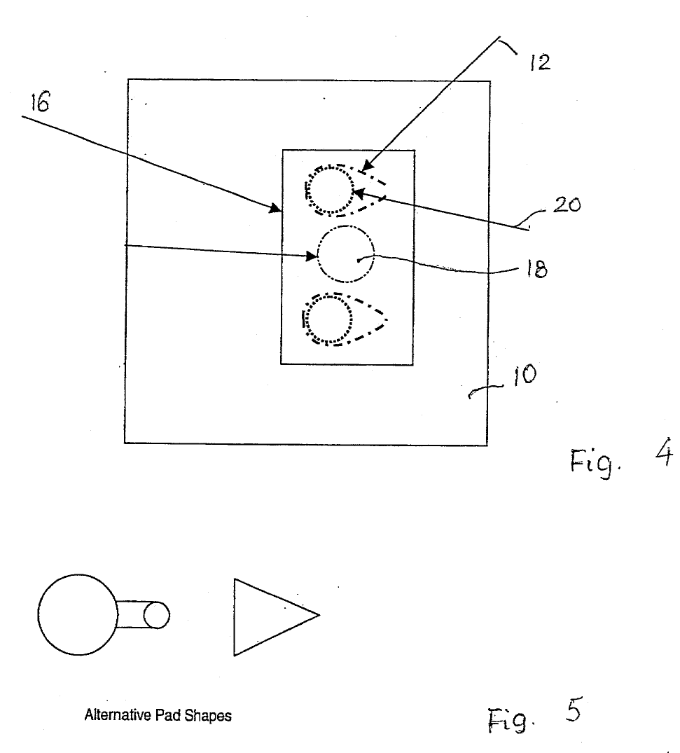

As seen in FIG. 4, the solder bumps are conveniently of a circular shape. While FIG. 2 shows the pads on the substrate and the solder bumps on the chip (element) 16, it is within the scope of the invention to reverse this arrangement so that the pads are provided on the chip and the solder bumps on the substrate, as long as the shape of the pads is asymmetrical enabling a non-uniform flow of the solder upon heating and consequential tilt of the chip relative to the substrate. It is also conceivable to provide solder pads on both the substrate and the chip (element), one set or both set of the pads being asymmetrical, and place solder bumps on either the substrate pads or the chip pads before assembly.

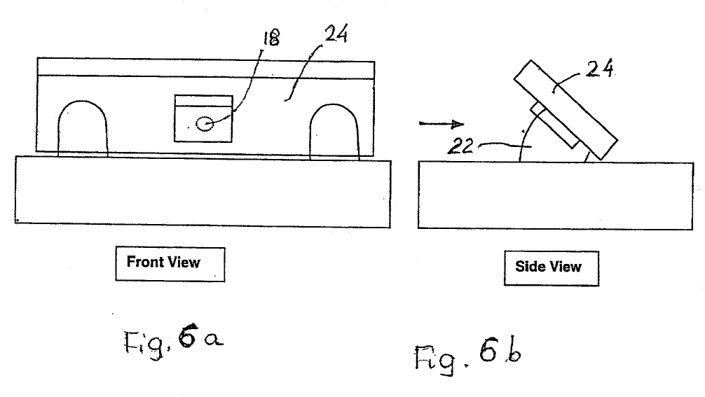

As shown by way of example in FIG. 5, numerous shapes of the asymmetric pads are possible, the objective being that the solder flow non-symmetrically upon heating (as explained hereinbelow) and that the amount of the solder relative to the size of the pad was sufficient to form a “hill” 20 (FIG. 6b) to promote the tilt of the chip.

Once the temporary immobilization of the chip 16 on the substrate 10 takes place (FIG. 3), the chip being otherwise unsupported by pick-up head 14 or other means, the assembly is placed at elevated temperature, e.g. on a heating tray. It can be seen that the chip 16 at this stage is disposed horizontally (in parallel) relative to the substrate, for example as a result of its release from the pick-up head 14. The temperature of the heating step is selected such that the solder 12 undergoes a reflow over the surface of the corresponding pad, forcing the chip to tilt to one side about the axis formed by the two (or more) pads.

The result of this operation is shown in FIG. 6a (front view) and 6b (side view). It will be seen that the tilted position of the chip enables exposure of the photodiode active area 18 to a light beam that may be incident on the photodiode from a direction indicated by an arrow in FIG. 6b. It will also be noted that the assembly of FIGS. 6a and 6b includes a submount 24 to which the chip is permanently secured.

While the present disclosure and drawings describe and illustrate a single photodiode assembly, it will be recognized that the invention may be used in the assembly of a large array of small electronic elements. In this context, the known technologies (MEMS, bump transfer, bump printing, flip-chip) can be used in a routine manner to produce an array of relatively uniform tilted elements on a substrate in a controlled manner.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method of bonding an element to a substrate, the method comprising:
a) providing a substrate having a generally flat surface,
b) placing two or more solder bumps on either the substrate or on the element, the bumps defining a single axis,
c) providing means for asymmetrical flow of the solder bumps upon melting,
d) effecting a contact of the element with the substrate via the solder bumps, and
e) heating the solder bumps to cause a non-uniform flow of the solder bumps and a tilting displacement of the element substantially about the axis defined by the solder bumps.

2. The method according to claim 1 wherein the element is attached to a transfer device before the step d).

3. The method of claim 1 wherein the means for asymmetrical solder flow are pads disposed in an arrangement corresponding to the placement of the solder bumps, the pads having a non-symmetric shape relative to an axis connecting the pads.

4. The method of claim 3 wherein the pads are disposed on the substrate and the solder bumps are disposed on the element.

5. The method of claim 3 wherein the pads are disposed on the element and the solder bumps are disposed on the substrate.

6. The method of claim 3 wherein the pads have a generally triangular shape.

7. The method of claim 1 wherein the element comprises an optoelectronically active area.

8. An assembly comprising a substrate and an element secured to the substrate at an angle with a solder, the assembly made by the process of claim 1.
